(19) United States
(12) Patent Application Publication
(10) Pub. No.: US 2016/0150125 A1
(43) Pub. Date: May 26, 2016

(54) INFORMATION PROCESSING APPARATUS, INFORMATION PROCESSING SYSTEM, AND CONTROL METHOD OF INFORMATION PROCESSING APPARATUS

(71) Applicant: Shunsuke YANO, Kanagawa (JP)

(72) Inventor: Shunsuke YANO, Kanagawa (JP)

(73) Assignee: RICOH COMPANY, LTD., Tokyo (JP)

(21) Appl. No.: 14/945,606

(22) Filed: Nov. 19, 2015

(30) Foreign Application Priority Data
Nov. 26, 2014 (JP) 2014-238932

(51) Int. Cl. H04N 1/44

(52) U.S. Cl. CPC H04N 1/4433; H04N 1/4413; H04N 2201/0094

(57) ABSTRACT

An information processing apparatus for providing a predetermined function, the information processing apparatus including a usage restriction unit configured to restrict usage of the information processing apparatus in a time period defined in advance; a receiving unit configured to receive application information for applying to use the information processing apparatus in the time period defined in advance; an approval unit configured to perform an approval process on the application information received by the receiving unit; and an outside hours authentication unit configured to authenticate a user of the information processing apparatus by using outside hours authentication information based on the application information approved by the approval unit, in the time period defined in advance.

### BACKGROUND OF THE INVENTION

1. Field of the Invention

The present invention relates to an information processing apparatus, an information processing system, and a control method of an information processing apparatus.

2. Description of the Related Art

For example, there is known an image forming apparatus, etc., that allows the usage of an image forming function such as printing, copying, scanning, fax transmission, etc., based on an authentication result by an IC card that is an employee ID card, an authentication result by identification information and a password of a user, etc.

Furthermore, for example, in order to prevent unauthorized use outside office hours such as early in the morning, at nighttime, on holidays, etc., there is known an image forming apparatus that implements control such that only a particular person such as the administrator can use the image forming apparatus within a time period between a usage end time and a usage start time defined in advance (see, for example, Patent Document 1).

According to the technology disclosed in Patent Document 1, for example, even when it becomes necessary to use the image forming apparatus outside office hours due to work-related circumstances, it is difficult for a general user to use the image forming apparatus outside office hours. Furthermore, if a general user is registered as an administrator, etc., so that the general user can use the image forming apparatus outside office hours, it is difficult to suppress the registered general user from using the image forming apparatus for purposes other than business.

As described above, in an information processing apparatus such as an image forming apparatus in which usage during a predetermined time period is restricted, it has been difficult to suppress usage of the information processing apparatus for purposes other than the intended purpose, while allowing a general user to use the information processing apparatus within the predetermined time period described above.

Patent Document 1: Japanese Laid-Open Patent Publication No. 2006-229711

### SUMMARY OF THE INVENTION

The present invention provides an information processing apparatus, an information processing system, and a control method of information processing apparatus, in which one or more of the above-described disadvantages are eliminated.

According to an aspect of the present invention, there is provided an information processing apparatus for providing a predetermined function, the information processing apparatus including a usage restriction unit configured to restrict usage of the information processing apparatus in a time period defined in advance; a receiving unit configured to receive application information for applying to use the information processing apparatus in the time period defined in advance; an approval unit configured to perform an approval process on the application information received by the receiving unit; and an outside hours authentication unit configured to authenticate a user of the information processing apparatus by using outside hours authentication information based on the application information approved by the approval unit, in the time period defined in advance.

According to an aspect of the present invention, there is provided an information processing system including a first information processing apparatus for providing a predetermined function and a second information processing apparatus for managing the first information processing apparatus, the information processing system including a usage restriction unit configured to restrict usage of the first information processing apparatus in a time period defined in advance; a receiving unit configured to receive application information for applying to use the first information processing apparatus in the time period defined in advance; an approval unit configured to perform an approval process on the application information received by the receiving unit; and an outside hours authentication unit configured to authenticate a user of the first information processing apparatus by using outside hours authentication information based on the application information approved by the approval unit, in the time period defined in advance.

According to an aspect of the present invention, there is provided a control method of an information processing apparatus for providing a predetermined function, the control method including restricting, by the information processing apparatus, usage of the information processing apparatus in a time period defined in advance; receiving, by the information processing apparatus, application information for applying to use the information processing apparatus in the time period defined in advance; performing, by the information processing apparatus, an approval process on the application information received at the receiving; and authenticating, by the information processing apparatus, a user of the information processing apparatus by using outside hours authentication information based on the application information approved by the approval process, in the time period defined in advance.

### BRIEF DESCRIPTION OF THE DRAWINGS

Other objects, features and advantages of the present invention will become more apparent from the following detailed description when read in conjunction with the accompanying drawings, in which:

FIG. 1 illustrates a configuration example of an information processing system according to a first embodiment;

FIG. 2 illustrates a hardware configuration of an image forming apparatus according to the first embodiment;

FIG. 3 illustrates a hardware configuration example of a computer according to the first embodiment;

FIG. 4 illustrates a functional configuration of the image forming apparatus according to the first embodiment;

FIG. 5 is a sequence chart indicating an example of an application, approval process according to the first embodiment;

FIGS. 6A and 6B illustrate examples of application information and approval information according to the first embodiment;

FIG. 7 is a sequence chart indicating an example of a usage process outside usage hours according to the first embodiment;

FIG. 8 is a flowchart indicating a flow a process by the image forming apparatus according to the first embodiment;

FIG. 9 illustrates an example of usage restriction information according to the first embodiment;

FIG. 10A illustrates an example of within hours authentication information according to the first embodiment;

FIG. 10B illustrates an example of outside hours authentication information according to the first embodiment;

FIG. 10C illustrates another example of the outside hours authentication information according to the first embodiment;

FIGS. 11A and 11B illustrate examples of usage information according to the first embodiment;

FIG. 12 is a sequence chart of an authentication process outside usage hours according to the first embodiment;

FIG. 13 illustrates an example of outside hours authentication information according to a modification example;

FIG. 14 illustrates a configuration example of the information processing system according to a second embodiment;

FIG. 15 illustrates a functional configuration of the information processing system according to the second embodiment;

FIG. 16 is a sequence chart indicating an example of an application, approval process according to the second embodiment;

FIG. 17 illustrates an example of the outside hours authentication information according to the second embodiment; and

FIG. 18 is a sequence chart indicating an example of a usage process outside usage hours according to the second embodiment.

### DETAILED DESCRIPTION OF THE PREFERRED EMBODIMENTS

A description is given, with reference to the accompanying drawings, of embodiments of the present invention.

### First Embodiment

### <System Configuration>

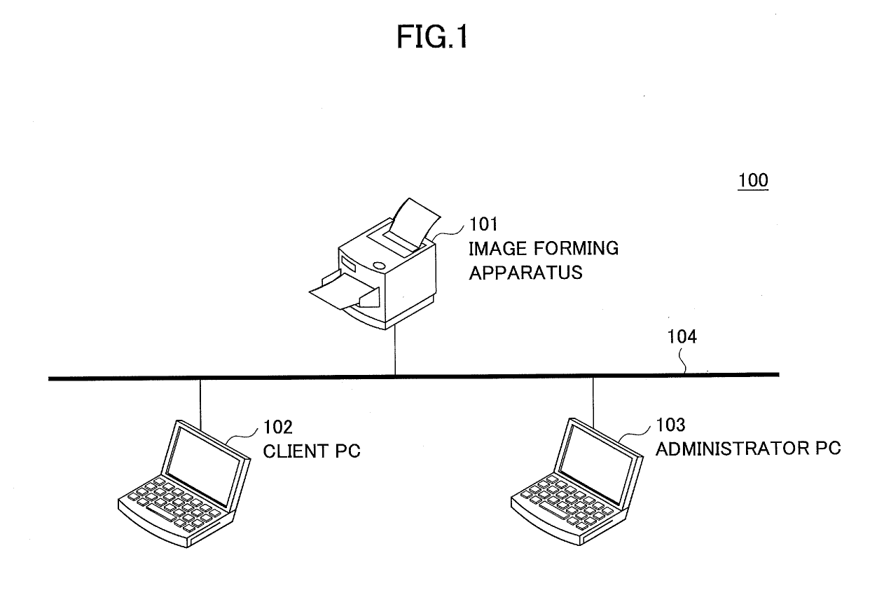

FIG. 1 illustrates a configuration example of an information processing system according to a first embodiment. An information processing system 100 includes, for example, an image forming apparatus 101, a client PC (Personal Computer) 102, an administrator PC 103, etc., which are connected to a network 104 such as the Internet and a LAN (Local Area Network).

The image forming apparatus 101 is a multifunction peripheral including functions such as those of a printer, a copier, a scanner, a fax machine, etc. Furthermore, the image forming apparatus 101 according to the present embodiment includes a security function for prohibiting usage of the image forming apparatus 101 during a time period defined in advance (for example, outside business hours), in order to prevent unauthorized use of the image forming apparatus 101, for example, early in the morning, at nighttime, on holidays, outside office hours, etc. Note that the image forming apparatus 101 is an example of an information processing apparatus including a function of restricting usage during a time period defined in advance. For example, the image forming apparatus 101 may be an image forming apparatus having a single function, such as a copier, a scanner, a printer, a fax machine, etc., or an information terminal such as a PC, a smartphone, a tablet terminal, etc. Alternatively, the image forming apparatus 101 may be an office device having a communication function such as a TV conference device, an electronic blackboard, etc.

The client PC 102 is an information terminal of a user using the image forming apparatus 101. By using the client PC 102, the user of the image forming apparatus 101 can use functions of the image forming apparatus 101 such as printing, scanning, copying, fax transmission, etc., and can control the image forming apparatus 101, etc.

For example, the user of the image forming apparatus 101 can access the web page for usage application provided by the image forming apparatus 101 from the client PC 102, and make a usage application for using the image forming apparatus 101 in a time period during which the usage is restricted. Note that the client PC 102 is an example of an information processing apparatus for controlling the image forming apparatus 101. For example, the client PC 102 may be an information terminal other than a PC, such as a tablet terminal or a smartphone held by the user.

The administrator PC 103 is an information terminal of the administrator who approves the application information of the user of the image forming apparatus 101, such as the supervisor of the user or a system administrator. For example, the administrator can access the web page for approval provided by the image forming apparatus 101 from the administrator PC 103, and perform a process of approving the usage application from the user.

By the above configuration, in the information processing system 100, it is possible to prohibit the usage of the image forming apparatus 101 during a time period defined in advance (for example, outside business hours).

Furthermore, for example, when the user needs to use the image forming apparatus 101 due to work-related circumstances, etc., in the time period during which usage is prohibited, the user can use the client PC 102 to make a usage application for using the image forming apparatus 101. At this time, as application information, the user inputs predetermined information such as the identification information of the user, the time period of using the image forming apparatus 101 (usage period), etc.

When the usage application is received from the user, for example, the image forming apparatus 101 reports to the administrator that the usage application has been received. The administrator that has received the report uses the administrator PC 103 to confirm the application information and perform an approval process. The image forming apparatus 101 creates and updates authentication information (outside hours authentication information) to be used in the time period during which usage is prohibited, based on the application information approved by the administrator.

In the time period during which usage is prohibited, the image forming apparatus 101 authenticates the user of the image forming apparatus 101 by using the outside hours authentication information based on the approved application information. Accordingly, the user is able to use the image forming apparatus 101 in the time period during which usage of the image forming apparatus 101 is prohibited, within a range of the usage period approved by the administrator.

Therefore, according to the present embodiment, with respect to an information processing apparatus (for example, the image forming apparatus 101) for which usage is restricted during a predetermined time period, it is possible to easily suppress the usage for purposes other than the intended purpose while allowing the user to use the information processing apparatus during the above predetermined time period.

### <Hardware Configuration>

### (Hardware Configuration of Image Forming Apparatus)

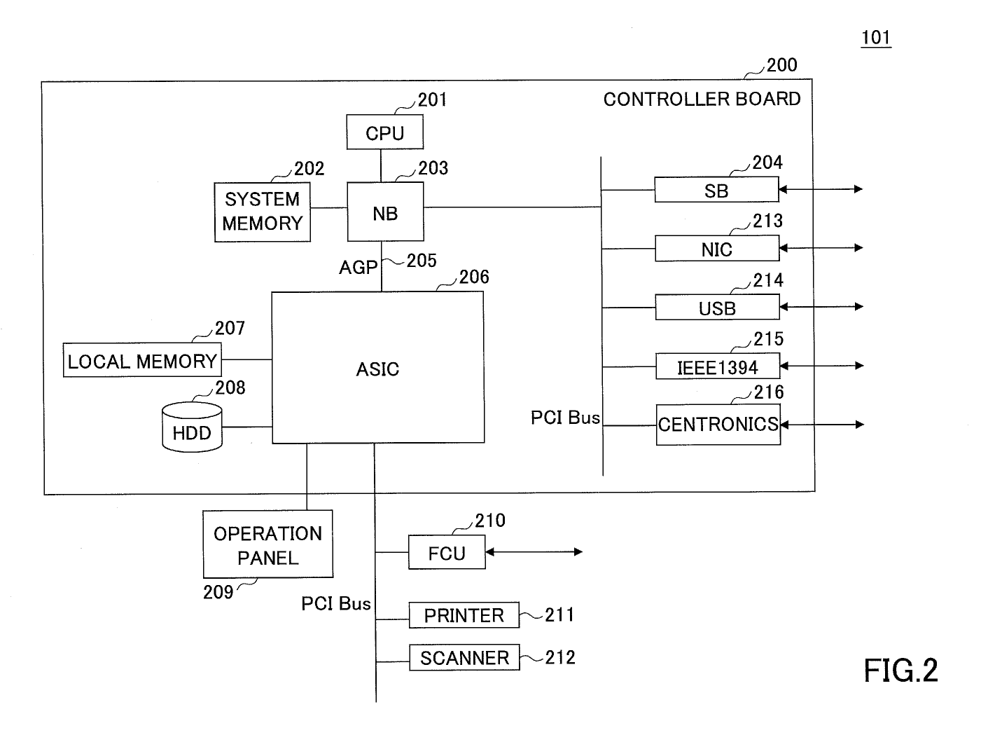

FIG. 2 illustrates a hardware configuration of the image forming apparatus 101 according to the first embodiment. For example, the image forming apparatus 101 includes a controller board 200, an operation panel 209, a FCU (Facsimile Control Unit) 210, and hardware engines such as a printer 211, a scanner 212, etc.

The controller board 200 includes a configuration of a general computer, such as a CPU (Central Processing Unit) 201, a system memory 202, a NB (North Bridge) 203, a SB (South Bridge) 204, an ASIC (Application Specific Integrated Circuit) 206, a local memory 207, a HDD (Hard Disk Drive) 208, an NIC (Network Interface Card) 213, a USB (Universal Serial Bus) interface 214, an IEEE 1394 interface 215, and a centronics interface 216.

The operation panel 209 is connected to the ASIC 206 of the controller board 200. Furthermore, the SB 204, the NIC 213, the USB interface 214, the IEEE 1394 interface 215, and the centronics interface 216 are connected to the NB 203 by a PCI bus. Furthermore, the FCU 210, the printer 211, and the scanner 212 are connected to the ASIC 206 of the controller board 200 by a PCI bus.

Note that in the controller board 200, the local memory 207, the HDD 208, etc., are connected to the ASIC 206, and the CPU 201 and the ASIC 206 are connected via the NB 203 of the CPU chip set. Furthermore, the ASIC 206 and the NB 203 are not connected via the PCI bus, but are connected via an AGP (Accelerated Graphics Port) 205 for the purpose of increasing the speed.

The CPU 201 is a processor for controlling the entire image forming apparatus 101. The CPU 201 executes programs stored in the HDD 208, etc., such as the operating system, applications, and various services, and implements the functions of the image forming apparatus 101.

The NB 203 is a bridge for connecting the CPU 201, the system memory 202, the SB 204, and the ASIC 206. The system memory 202 is a memory used as a drawing memory, etc., of the image forming apparatus 101. The SB 204 is a bridge for connecting the NB 203 and the PCI bus, and peripheral devices. Furthermore, the local memory 207 is, for example, a memory used as an image buffer for copying and a code buffer. The system memory 202 or the local memory 207 may be simply referred to as a memory or a storage area in the following descriptions.

The ASIC 206 is an integrated circuit for the purpose of image processing including hardware elements for image processing. The HDD 208 is a storage device for storing, for example, images, programs, font data, forms, etc.

Furthermore, the operation panel 209 is a hardware element (operation unit) for receiving input operations from the user, and also a hardware element (display unit) for displaying information to the user. The FCU 210 sends and receives fax data according to a standard such as G3 FAX (Group 3 Facsimile). The printer 211 performs printing according to, for example, the control by a program operating in the CPU 201. The scanner 212 reads images according to, for example, the control by a program operating in the CPU 201.

The NIC 213 is a communication interface for connecting the image forming apparatus 101 to the network 104 and sending and receiving data. The USB interface 214 is a serial bus interface for connecting, for example, a recording medium such as a USB memory and various USB devices. The IEEE 1394 interface 215 is an interface for connecting a device complying with the IEEE 1394 high-speed serial bus standard. The centronics interface 216 is an interface for connecting a device complying with a centronics specification that is a specification of a parallel port.

For example, as described above, the image forming apparatus 101 according to the present embodiment includes a configuration of a general computer that implements various functions by programs operating in the CPU 201.

### (Hardware Configuration of Computer)

The client PC 102 and the administrator PC 103 have a configuration of a general computer.

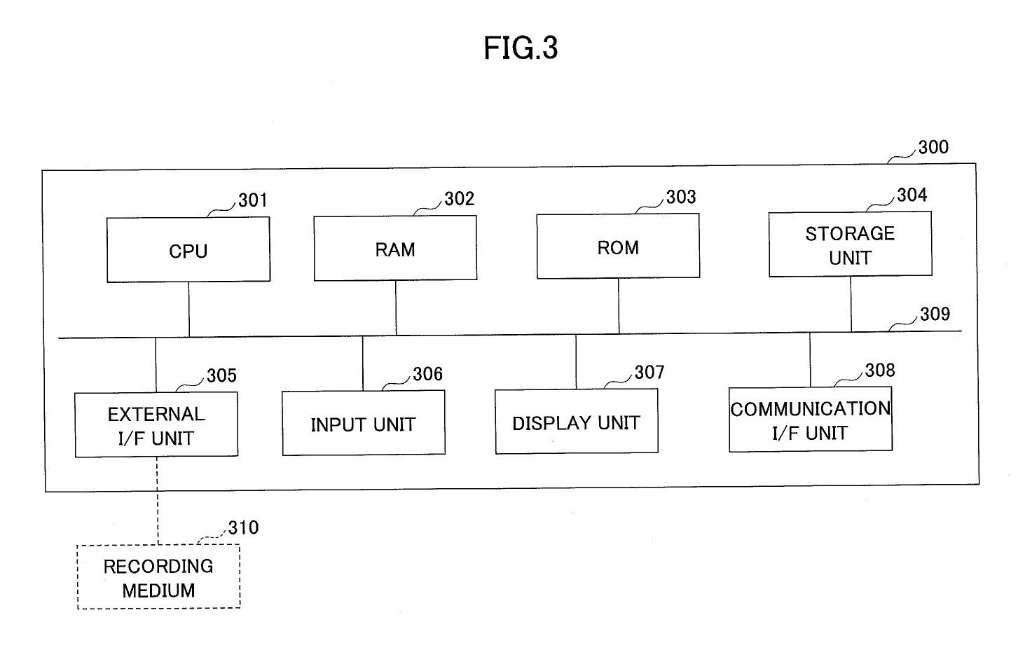

FIG. 3 illustrates a hardware configuration example of a computer according to the first embodiment. A computer 300 includes, for example, a CPU 301, a RAM (Random Access Memory) 302, a ROM (Read Only Memory) 303, a storage unit 304, an external I/F (Interface) unit 305, an input unit 306, a display unit 307, a communication I/F unit 308, a bus 309, etc.

The CPU 301 is an arithmetic device for implementing various functions of the computer 300, by loading the programs and data stored in the ROM 303, the storage unit 304, etc., into the RAM 302, and executing processes. The RAM 302 is a volatile memory used as a work area, etc., of the CPU 301. The ROM 303 is a non-volatile memory for holding programs and data even after the power is turned off, and is constituted by, for example, a flash ROM, etc.

The storage unit 304 is a storage device such as a HDD, SSD (Solid State Drive), etc., and stores an OS (Operating System), an application program, various kinds of data, etc.

The external I/F unit 305 is an interface between the computer 300 and an external device. The external device is a recording medium 310, such as a USB memory, a memory card, an optical disk, etc. The input unit 306 includes a pointing device such as a mouse, and a keyboard, etc., and is used for inputting operation signals in the computer 300. The display unit 307 includes a display such as a LCD (Liquid Crystal Display), and displays processing results, etc., by the computer 300.

The communication I/F unit 308 is an interface for connecting the computer 300 to the network 104. The computer 300 can exchange data with other computers, the image forming apparatus 101, etc., via the communication I/F unit 308. The bus 309 is commonly connected to the respective elements described above, and transmits address signals, data signals, various control signals, etc.

Note that the configuration of FIG. 3 is merely an example. For example, the computer 300 may have the input unit 306 and the display unit 307 provided externally, and the input unit 306 and the display unit 307 may integrally constitute a display input device such as a touch panel display.

### <Functional Configuration>

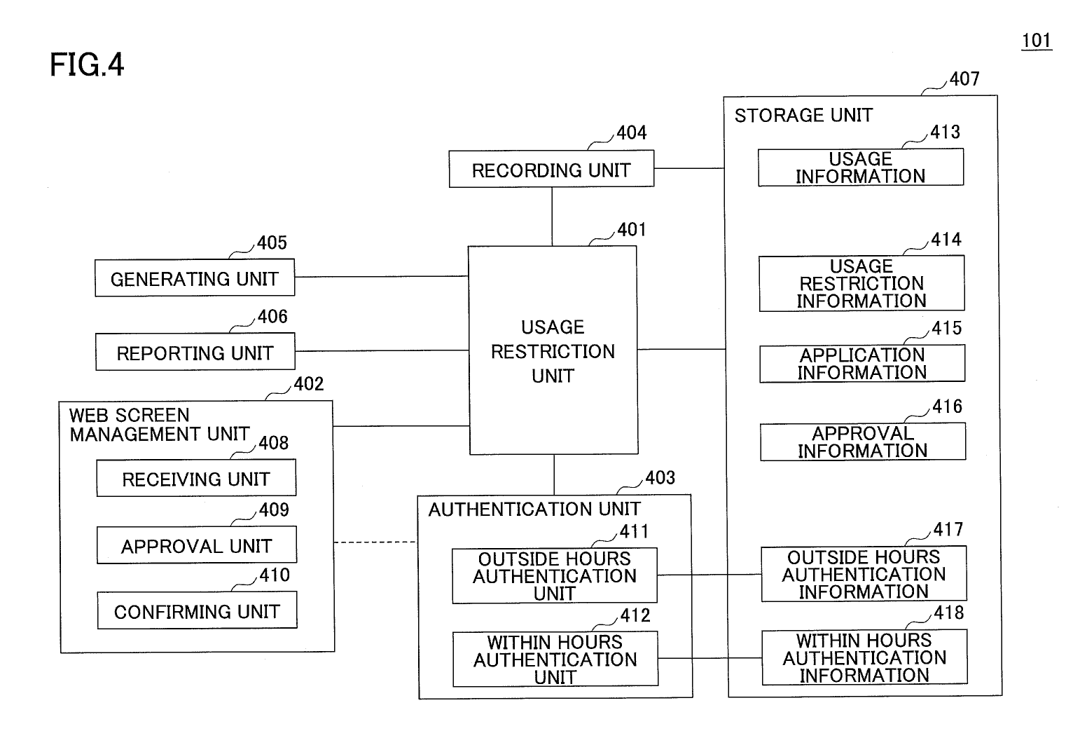

FIG. 4 illustrates a functional configuration of the image forming apparatus 101 according to the first embodiment. The image forming apparatus 101 includes a usage restriction unit 401, a web screen management unit 402, an authentication unit 403, a recording unit 404, a generating unit 405, a reporting unit 406, and a storage unit 407. Note that it is assumed that the image forming apparatus 101 also includes functions relevant to image forming such as those of a printer, a copier, a scanner, a fax machine, etc., and general functions such as a communication function.

The usage restriction unit 401 is a unit for restricting the usage of the image forming apparatus 101 during a time period defined in advance, and is realized by, for example, programs, etc., operating in the CPU 201 illustrated in FIG. 2. The image forming apparatus 101 stores, in advance, the information indicating the time period during which usage of the image forming apparatus 101 is restricted (for example, usage is prohibited), in the storage unit 407 as usage restriction information 414, for example. Furthermore, the usage restriction unit 401 restricts (for example, prohibits) the usage of the image forming apparatus 101 by general users, based on the usage restriction information 414.

Note that in the following description, the time period during which usage of the image forming apparatus 101 is restricted by the usage restriction unit 401, is referred to as “outside usage hours”. Meanwhile, the time period during which usage of the image forming apparatus 101 is not restricted by the usage restriction unit 401, is referred to as “within usage hours”.

The web screen management unit 402 is a unit for providing a web page to, for example, information terminals such as the client PC 102 and the administrator PC 103, and is realized by, for example, programs, etc., operating in the CPU 201 illustrated in FIG. 2. The web screen management unit 402 according to the present embodiment includes a receiving unit 408, an approval unit 409, and a confirming unit 410.

The receiving unit 408 is a unit for receiving application information for applying to use the image forming apparatus 101 during the outside usage hours described above. For example, the receiving unit 408 provides a web page for receiving the application information for applying for usage during outside usage hours. When the user needs to use the image forming apparatus 101 during outside usage hours, the user can access, from the client PC 102, etc., the web page used for application provided by the receiving unit 408, and input application information for applying to use the image forming apparatus 101 during outside usage hours.

The receiving unit 408 stores the received application information in the storage unit 407 as application information 415, via the usage restriction unit 401, for example.

The approval unit 409 is a unit for performing an approval process on the application information 415 received by the receiving unit 408. The approval unit 409 provides, for example, a web page for the administrator to approve the application information 415. The administrator can access, from the administrator PC 103, etc., the web page used for approval provided by the approval unit 409, and approve the application information 415 received by the receiving unit 408.

Note that the approval unit 409 may automatically perform the approval process on the application information 415 based on an approval rule, etc., defined in advance, or may request an external approval server, etc., to perform the approval process.

The approval unit 409 outputs the approved application information to, for example, the usage restriction unit 401. The usage restriction unit 401 stores the application information approved by the approval unit 409 in the storage unit 407 as approval information 416, for example.

The confirming unit 410 is a unit for confirming the usage status of the image forming apparatus 101. The confirming unit 410 provides, for example, a web page for the administrator, etc., to confirm usage information 413 of the image forming apparatus 101. The administrator can access, from the administrator PC 103, etc., a web page used for confirming the usage information provided by the confirming unit 410, and confirm the usage information 413 indicating the usage status, etc., of the image forming apparatus 101.

The authentication unit 403 is a unit for authenticating the user of the image forming apparatus 101, and is realized by, for example, programs, etc., operating in the CPU 201 illustrated in FIG. 2. The authentication unit 403 includes an outside hours authentication unit 411 for authenticating a user during outside usage hours, and a within hours authentication unit 412 for authenticating a user within usage hours.

The outside hours authentication unit 411 authenticates a user during the outside usage hours of the image forming apparatus 101, based on, for example, outside hours authentication information 417 stored in the storage unit 407. The outside hours authentication information 417 is authentication information based on the approval information 416 that is application information approved by the approval unit 409, and includes information such as the identification information of the approved user and the approved usage period. Accordingly, the outside hours authentication unit 411 allows the authentication within a range of the usage period approved by the approval unit 409 during the outside usage hours, with respect to the user approved by the approval unit 409.

The within hours authentication unit 412 authenticates the user based on, for example, within hours authentication information 418 stored in the storage unit 407, within the usage hours of the image forming apparatus 101. In the within hours authentication information 418, the identification information and the authentication information (for example, password, card ID, etc.) of the user who has been allowed to use the image forming apparatus 101 within the usage hours, are stored in advance. Accordingly, the within hours authentication unit 412 allows the authentication of the user whose information is stored in the within hours authentication information 418, within the usage hours.

The recording unit 404 is a unit for recording information relevant to the usage contents of the image forming apparatus 101 during outside usage hours, as the usage information 413, etc., in the storage unit 407, and is realized by, for example, programs, etc., operating in the CPU 201 illustrated in FIG. 2. The usage information 413 includes, for example, information (user ID, etc.) for identifying the user who has used the image forming apparatus 101 during the outside usage hours, and information (image information, etc.) for identifying the process contents of the image forming apparatus 101.

The generating unit 405 is a unit for generating authentication information (for example, a password) corresponding to the approved application information 415, when the application information 415 is approved by the approval unit 409, and is realized by, for example, programs, etc., operating in the CPU 201 illustrated in FIG. 2.

The reporting unit 406 reports to the administrator that is to approve the application information 415, that the receiving unit 408 has received the application information 415. Furthermore, the reporting unit 406 reports, to the client PC 102 of the user, the approval result by the approval unit 409 and the authentication information generated by the generating unit 405. The reporting unit 406 is realized by, for example, programs, etc., operating in the CPU 201 illustrated in FIG. 2.

The storage unit 407 is a unit for storing the usage information 413, the usage restriction information 414, the application information 415, the approval information 416, the outside hours authentication information 417, the within hours authentication information 418, etc., described above. The storage unit 407 is realized by, for example, the HDD 208, etc., illustrated in FIG. 2. Furthermore, the storage unit 407 may be an external storage device such as a server connected to the network 104 and an external storage connected to the USB interface 214.

### <Process Flow>

### (Application, Approval Process)

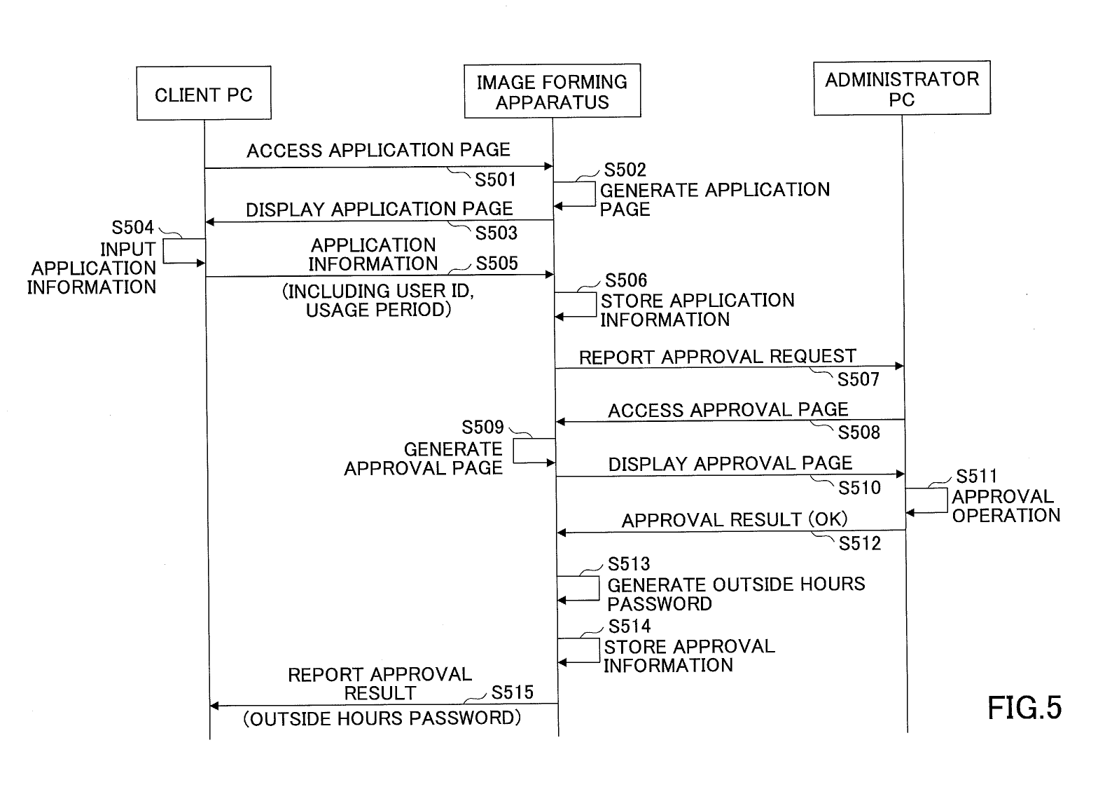

FIG. 5 is a sequence chart indicating an example of an application, approval process according to a first embodiment.

In step S501, the user who wants to use the image forming apparatus 101 outside usage hours, accesses, from the client PC 102, an application page that is a web page provided by the image forming apparatus 101. The access to the application page is performed by inputting, for example, from a general-purpose web browser of the client PC 102, access information such as the URL (Uniform Resource Locator) of the application page, the IP (Internet Protocol) address, and the port number. Alternatively, the user may access the application page by using an application program storing access information to the application page in advance.

When the receiving unit 408 of the image forming apparatus 101 receives access to the application page, the receiving unit 408 generates an application page for inputting application information for applying for usage outside usage hours (step S502), and displays the generated application page (step S503).

When the user inputs the application information in the application page (step S504), the receiving unit 408 of the image forming apparatus 101 acquires the input application information (step S505). The application information acquired by the receiving unit 408 is stored as application information 415 in the storage unit 407 by the usage restriction unit 401 (step S506).

After the application information 415 is stored, the reporting unit 406 of the image forming apparatus 101 reports an approval request to the administrator for reporting to the administrator that the application information 415 has been received (step S507). Note that FIG. 5 illustrates an example of a case where the approval request is reported to the administrator PC 103; however, the reporting unit 406 may report the approval request to the mail address of the administrator or the mobile phone number of the administrator. Accordingly, for example, even when the approver is not using the administrator PC when he has gone out, etc., the approver can receive the report of the approval request.

The administrator that has received the report of the approval request accesses an approval page provided by the approval unit 409 of the image forming apparatus 101, for example, by using the administrator PC 103 (step S508). Note that when the administrator has gone out, or has gone home, and cannot use the administrator PC 103, the administrator can access the approval page from an information terminal other than the administrator PC 103, such as a smartphone, a tablet terminal, etc.

For example, when access to the approval page is received from the administrator PC 103, etc., the approval unit 409 of the image forming apparatus 101 generates an approval page (step S509), and displays the generated approval page (step S510).

The administrator confirms the application information 415 in the approval page displayed on the administrator PC 103, and performs an approval operation of inputting whether to approve the application information 415 (step S511). The approval unit 409 of the image forming apparatus 101 acquires the approval result by the administrator (step S512). Note that the example of FIG. 5 illustrates an example where the application information 415 is approved.

When the application information 415 is approved, for example, the image forming apparatus 101 generates, by the generating unit 405, an outside hours password that is used by the outside hours authentication unit 411 for authenticating a user outside usage hours (step S513). Furthermore, the image forming apparatus 101 stores the generated outside hours password and the approved application information 415 in the storage unit 407 as approval information 416 (step S514).

The reporting unit 406 of the image forming apparatus 101 reports the approval result including the outside hours password generated by the generating unit 405, to the client PC 102 (step S515). Note that, when the approval of the application information 415 is rejected in step S511, the processes of steps S513 and S514 are not performed, and in step S515, an approval result indicating that the application information 415 is not approved, is reported to the client PC 102.

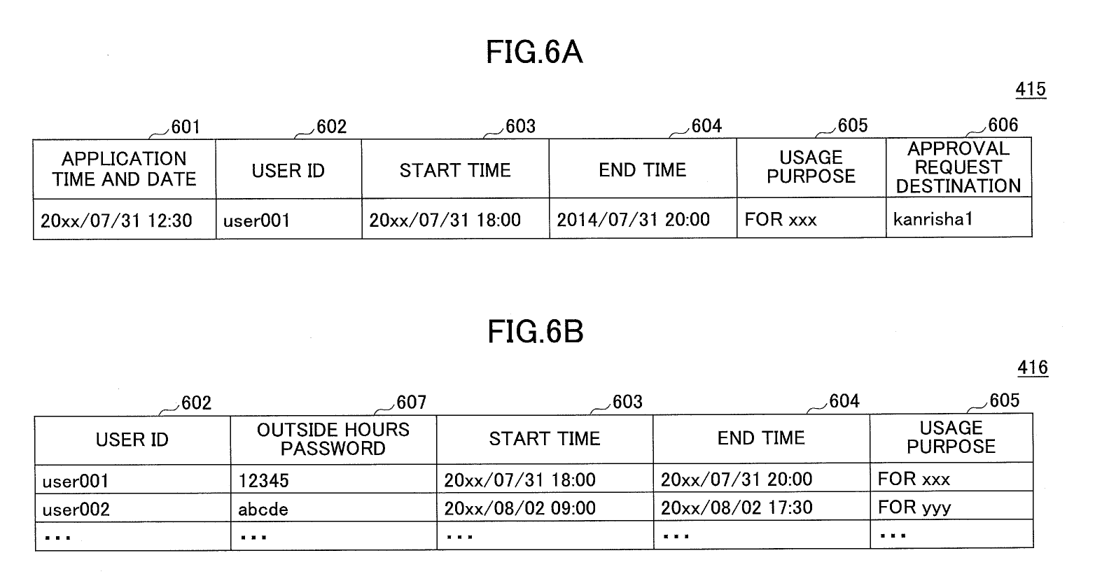

FIGS. 6A and 6B illustrate examples of application information and approval information according to the first embodiment. FIG. 6A illustrates an example of the application information 415, and FIG. 6B illustrates an example of the approval information 416.

In FIG. 6A, the application information 415 includes information such as an application time and date 601, a user ID 602, a start time 603, an end time 604, a usage purpose 605, an approval request destination 606, etc.

The application time and date 601 is the time and date on which the application of the application information is performed, and is information indicating, for example, the time and date on which the application information 415 is stored in the storage unit 407, the time and date on which the application information is input from the client PC 102, etc.

The user ID 602 is identification information of the user who has performed the application (for example, an employee ID). The start time 603 and the end time 604 are examples of information indicating the usage period in which the user wants to use the image forming apparatus 101, during the outside usage hours. The information indicating the usage period may be, for example, the start time 603 and the usage time (for example, one hour).

Preferably, the application information 415 includes the usage purpose 605, which is information indicating the usage purpose of the image forming apparatus 101 by the user. Accordingly, the administrator can easily determine whether to approve the application information 415.

Furthermore, preferably, the application information 415 includes the approval request destination 606, which is information indicating the administrator to which the approval of the application information 415 is requested. Accordingly, for example, the approval can be requested to different administrators depending on the user and the usage purpose.

In FIG. 6B, the approval information 416 includes information such as a user ID 602, an outside hours password 607, a start time 603, an end time 604, a usage purpose 605, etc. Among these, the user ID 602, the start time 603, the end time 604, and the usage purpose 605 are the same as the information included in the application information 415.

Furthermore, the approval information 416 includes, in addition to the information included in the application information 415, the outside hours password 607, etc., which is authentication information used for performing authentication outside usage hours by the outside hours authentication unit 411. The outside hours password 607 corresponds to the outside hours password 607 included in the approval result reported to the client PC 102 in step S515 of FIG. 5. Note that the outside hours password 607 is an example of authentication information used for authentication outside usage hours by the outside hours authentication unit 411.

### (Usage Process)

Next, a description is given of a usage process by the entire information processing system 100 outside usage hours of the image forming apparatus 101.

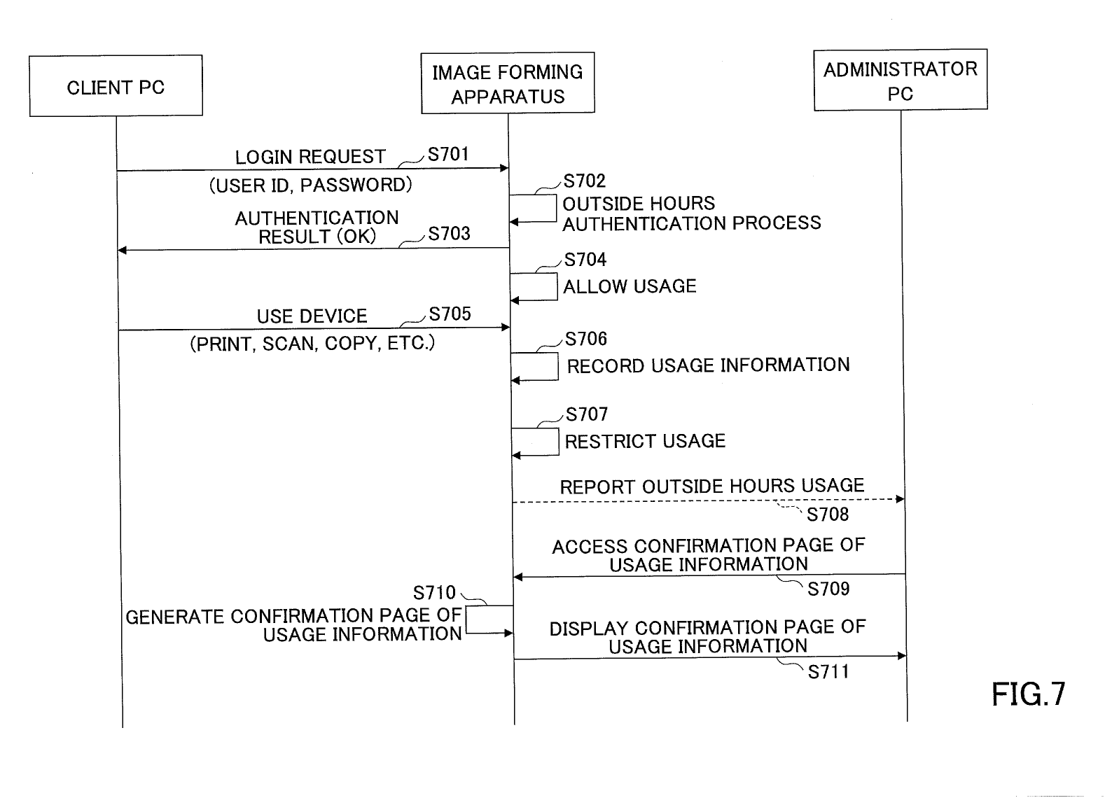

FIG. 7 is a sequence chart indicating an example of a usage process outside usage hours according to the first embodiment.

The user who is going to use the image forming apparatus 101 outside usage hours of the outside usage hours, requests login to the image forming apparatus 101, by using the outside hours password 607 included in the approval result reported in step S515 of FIG. 4 (step S701).

The image forming apparatus 101 that has received the login request outside usage hours performs an outside hours authentication process on the user requesting the login, by the outside hours authentication unit 411 (step S702), and reports the authentication result to the outside hours authentication process to the client PC 102 (step S702). Note that FIG. 7 illustrates an example where the outside hours authentication is allowed.

When the outside hours authentication is allowed in step S702, the usage restriction unit 401 of the image forming apparatus 101 releases the usage restriction, and allows the user to use the image forming apparatus 101 (step S704). Meanwhile, when the outside hours authentication is not allowed in step S702, the usage restriction unit 401 of the image forming apparatus 101 does not allow the user to use the image forming apparatus 101.

When the user of the client PC 102 receives the authentication result indicating that the outside hours authentication has been allowed in step S703, the user uses the image forming apparatus 101 to perform a predetermined process (for example, printing, scanning, copying, etc.) (step S705). At this time, the recording unit 404 of the image forming apparatus 101 records usage information including identification information of the user, process contents of the image forming apparatus 101 instructed by the user, etc., as the usage information 413, in the storage unit 407 (step S706).

When the user finishes using the device (logout, usage period ends, etc.), the usage restriction unit 401 of the image forming apparatus 101 resumes the usage restriction of the image forming apparatus 101 (step S707). Furthermore, when the image forming apparatus 101 is used outside usage hours, the reporting unit 406 may send a report to the administrator PC 103, etc., indicating that the image forming apparatus 101 has been used outside usage hours (step S708).

When the administrator accesses, from the administrator PC 103, a confirmation page for conforming the usage information 413 provided by the confirming unit 410 of the image forming apparatus 101 (step S709), the confirming unit 410 generates a confirmation page of the usage information 413, and displays the generated confirmation page (steps S710, S711). The administrator can confirm the usage information 413 of the image forming apparatus 101 outside usage hours, from the confirmation page of the usage information 413 displayed on the administrator PC 103.

Next, a description is given of the flow of a specific process of the image forming apparatus 101.

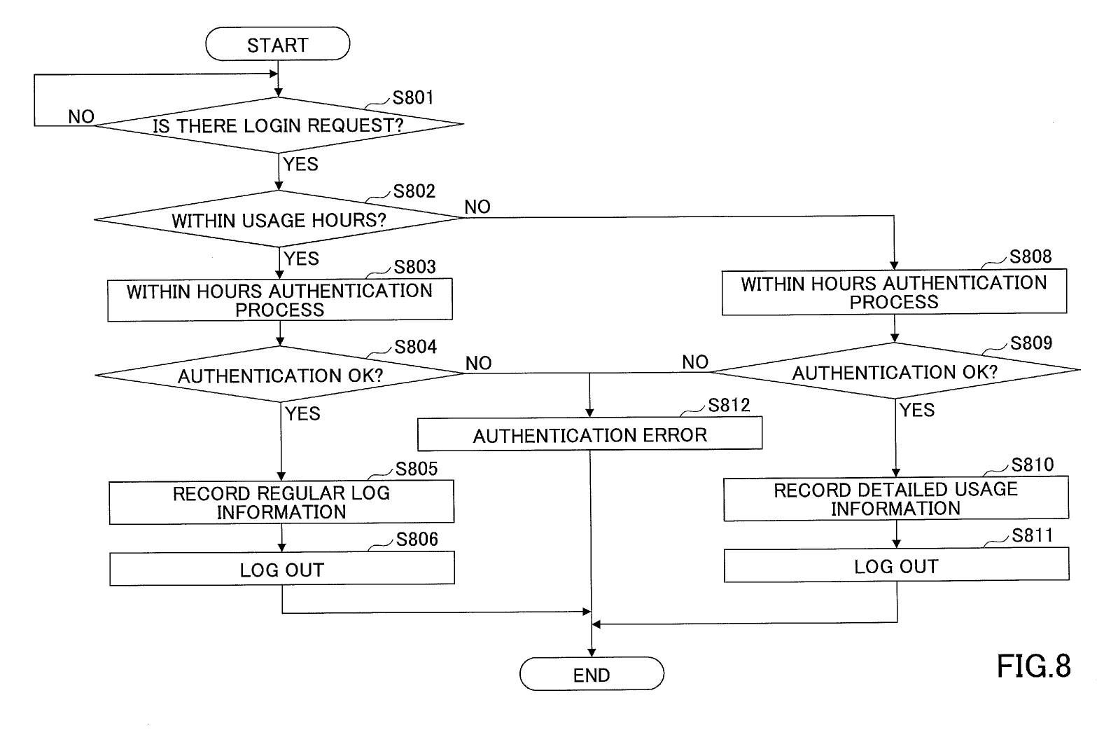

FIG. 8 is a flowchart indicating a flow a process by the image forming apparatus 101 according to the first embodiment.

When the authentication unit 403 of the image forming apparatus 101 determines that there is a login request from the user, for example, via the web screen management unit 402, etc. (step S801), the authentication unit 403 determines whether the present time is within usage hours (step S802). The image forming apparatus 101 can determine whether the present time is outside usage hours or within usage hours, based on the usage restriction information 414, etc., stored in the storage unit 407.

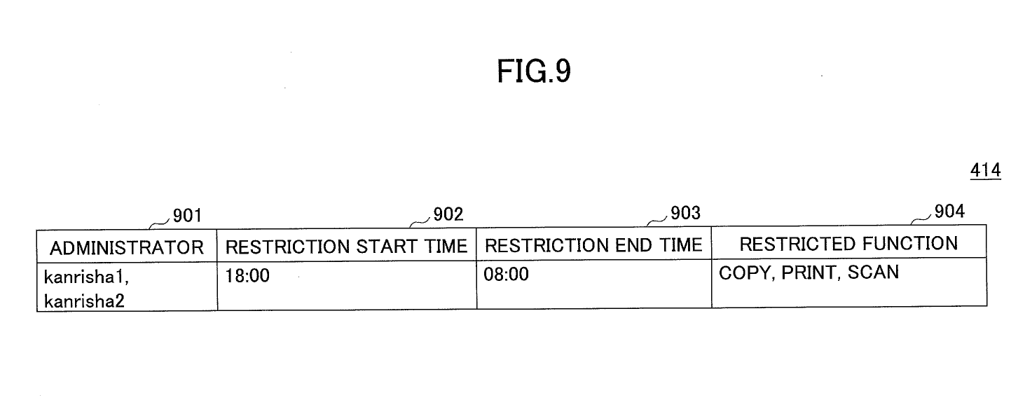

FIG. 9 illustrates an example of the usage restriction information 414 according to the first embodiment. In the example of FIG. 9, the usage restriction information 414 includes information such as administrator 901, restriction start time 902, restriction end time 903, restricted function 904, etc.

The administrator 901 is information of the administrator who is able to approve the usage outside usage hours of the image forming apparatus 101. The restriction start time 902 and the restriction end time 903 are examples of information indicating the usage time of the image forming apparatus 101. In the example of FIG. 9, the period from the restriction start time 902 to the restriction end time 903 corresponds to outside usage hours. Meanwhile, the period from the restriction end time 903 to the restriction start time 902 corresponds to within usage hours. The restricted function 904 is information indicating the function for which usage is restricted outside usage hours of the image forming apparatus 101.

Referring back to FIG. 8, the description of the flowchart is continued.

When it is determined to be within usage hours in step S802, the authentication unit 403 uses the within hours authentication unit 412 to perform a within hours authentication process that is a regular authentication process (step S803). The within hours authentication unit 412 authenticates the user based on the within hours authentication information 418 stored in the storage unit 407.

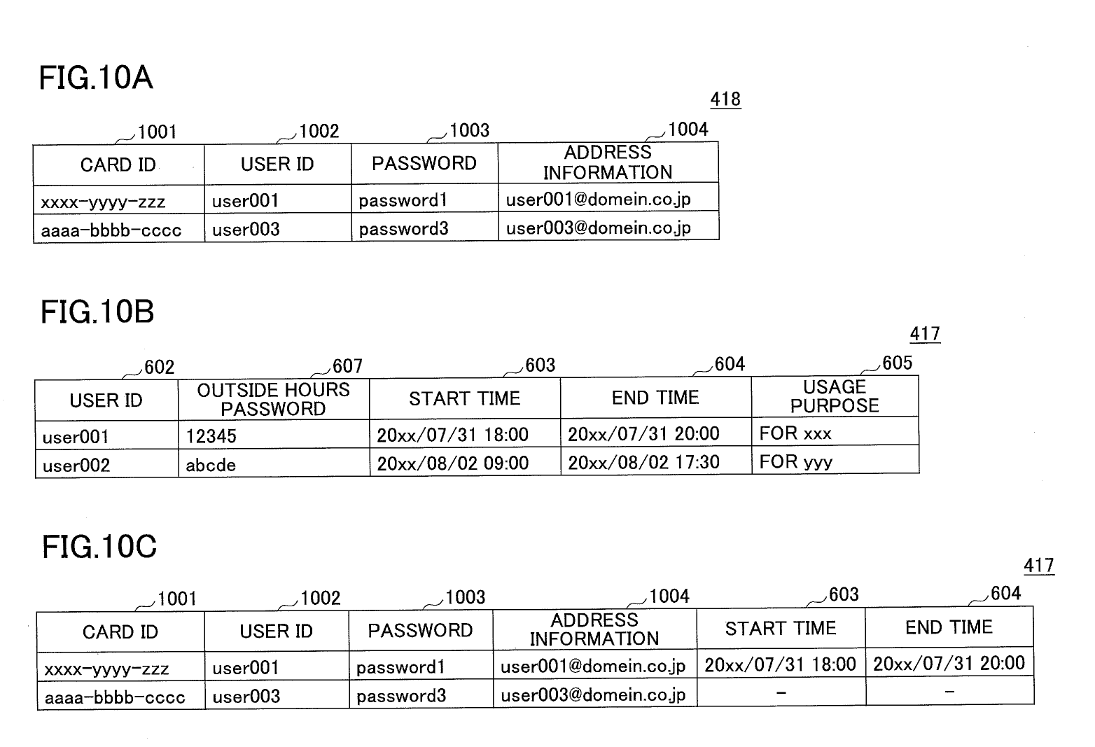

FIG. 10A illustrates an example of the within hours authentication information 418. The within hours authentication information 418 includes the authentication information of the user who is allowed to use the image forming apparatus 101 within usage hours of the image forming apparatus 101. For example, in the example of FIG. 10A, the within hours authentication information 418 includes information such as a card ID 1001, a user ID 1002, a password 1003, address information 1004, etc.

The card ID 1001 is information indicating the identification information of an ID card, for example, when the user is able to log into the image forming apparatus 101 by using an ID card such as an employee ID card of his own, etc. The user ID 1002 is identification information of the user. The password 1003 is password information for logging into the image forming apparatus 101 within usage hours by the user. The address information 1004 is information indicating the mail address of the user.

The within hours authentication unit 412 authenticates the user by matching information input at the time of login within usage hours, such as the card ID 1001 or the user ID 1002 and the password 1003, etc., to the information recorded in the within hours authentication information 418.

When the authentication is allowed in the within hours authentication process in step S803, the process shifts to the step S805. Meanwhile, when the authentication is not allowed in the within hours authentication process in step S803, the process shifts to step S812 (step S804).

When the process shifts to step S805, the image forming apparatus 101 stores the regular log information in the storage unit 407, according to the process of the user. The regular log information is a record of processes and operations of the image forming apparatus 101, including, for example, an access log indicating that accesses have been made to the image forming apparatus 101 by login or via a network, a job log indicating the history of jobs that have been generated at the image forming apparatus 101, etc. The regular log information does not necessarily include information for identifying the type of document that has been processed (for example, printing, scanning, copying, etc.) according to the instruction by the user. Thus, even when the user has instructed to perform a process for purposes other than business such as printing a document unrelated to business, etc., it is difficult to identify the process contents.

When the process instructed by the user ends, the image forming apparatus 101 performs a log out process, and ends the process (step S806).

Meanwhile, when it is determined not to be within usage hours in step S802, the authentication unit 403 uses the outside hours authentication unit 411 to perform an outside hours authentication process (step S808). The outside hours authentication unit 411 authenticates the user based on the outside hours authentication information 417 stored in the storage unit 407.

FIG. 10B illustrates an example of the outside hours authentication information 417. The outside hours authentication information 417 is authentication information based the approval information 416 that is application information approved by the approval unit 409. In the example of FIG. 10B, similar to the approval information 416 illustrated in FIG. 6B, the outside hours authentication information 417 includes information such as a user ID 602, an outside hours password 607, a start time 603, an end time 604, a usage purpose 605, etc. For example, as described above, the outside hours authentication unit 411 may almost directly use the approval information 416 as the outside hours authentication information 417. In this case, the image forming apparatus 101 may manage the approval information 416 and the outside hours authentication information 417 as one information item.

In this example, the user using the image forming apparatus 101 outside usage hours makes a login request to log into the image forming apparatus 101, by using the user ID 602 that is the identification information of the user and the outside hours password 607 reported in step S515 of FIG. 5. The outside hours authentication unit 411 performs an outside hours authentication process on the user, based on information including the user ID 602, the outside hours password 607, and the information of the usage period (start time 603 and end time 604).

FIG. 10C illustrates another example of the outside hours authentication information 417. In the example of FIG. 10C, similar to the within hours authentication information 418, the outside hours authentication information 417 includes a card ID 1001, a user ID 1002, a password 1003, address information 1004, etc., and further includes a start time 603 and an end time 604 which are included in the approval information 416. Among these, the start time 603 and the end time 604 are applied only to the user ID 1002 for which usage outside usage hours has been approved by the approval unit 409.

As described above, the image forming apparatus 101 may perform outside hours authentication on a user outside usage hours, regardless of the outside hours password 607.

In this case, the user makes a login request to log into the image forming apparatus 101 outside usage hours, by using the card ID 1001 or the user ID 1002 and the password 1003, similar to the case of within usage hours. Furthermore, the outside hours authentication unit 411 allows the outside hours authentication of the user, when authentication by using the card ID 1001 or the user ID 1002 and the password 1003 of the user is successful and also the time and date when the login is requested is included between the start time 603 and the end time 604.

Meanwhile, even when the authentication with the card ID 1001 or the user ID 1002 and the password 1003 is successful, if the time and date when the login is requested is not included between the start time 603 and the end time 604, the outside hours authentication unit 411 does not allow the outside hours authentication of the user.

Referring back to FIG. 8, the description of the flowchart is continued.

When the authentication is allowed in the outside hours authentication process of step S809, the process shifts to step S810. Meanwhile, when the authentication is not allowed in the outside hours authentication process of step S809, the process shifts to step S812 (step S809).

When the process shifts to step S810, the recording unit 404 of the image forming apparatus 101 records detailed usage information according to the process instructed by the user, as the usage information 413 in the storage unit 407. This usage information 413 includes information for identifying the user (for example, the user ID 1002), and information for identifying the process contents by the image forming apparatus 101 (for example, data of the image that has been printed, etc.).

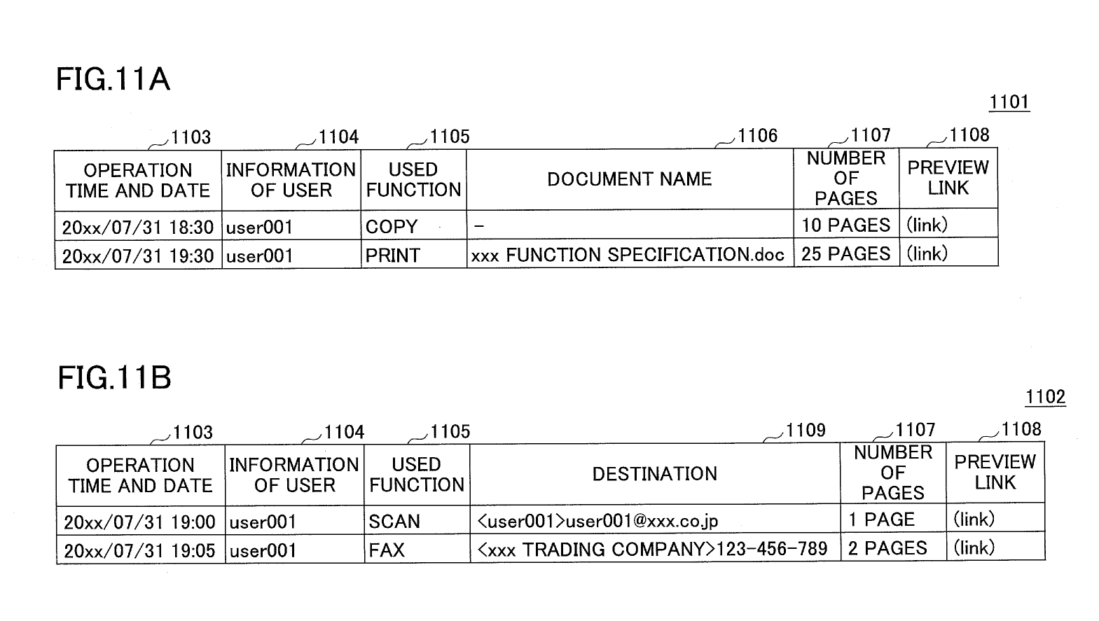

FIGS. 11A and 11B illustrate examples of usage information according to the first embodiment. FIG. 11A illustrates an example of usage information when the copy function and the print function have been used. Furthermore, FIG. 11B illustrates an example of usage information when the scan function and the fax function have been used.

In FIG. 11A, usage information 1101 includes information such as an operation time and date 1103, a user 1104, a used function 1105, a document name 1106, number of pages 1107, a preview link 1108, etc.

The operation time and date 1103 is information indicating the time and date when the image forming apparatus 101 has been operated outside usage hours. The user 1104 is information indicating the user who has used the image forming apparatus 101 at the operation time and date 1103. The used function 1105 is information indicating the function used at the operation time and date 1103. The document name 1106 is information indicating the file name of the document that has been printed, when the print function has been used. The number of pages 1107 is information indicating the number pages that has been processed by the copy function or the print function. The preview link 1108 is link information to the data of the process performed at the operation time and date 1103.

The administrator can view the document that has been printed or copied at the operation time and date 1103, by accessing the link destination indicated in the preview link 1108. Furthermore, the administrator can print the viewed document. Accordingly, the administrator can view the document that has been printed or copied outside usage hours, and therefore the administrator can confirm whether the user has used the image forming apparatus 101 for purposes other than business.

Similarly, In FIG. 11B, usage information 1102 includes information of an operation time and date 1103, a user 1104, a used function 1105, number of pages 1107, a preview link 1108, etc. Furthermore, instead of the document name 1106 in the usage information 1101, the usage information 1102 includes destination information 1109.

The destination information 1109 includes, for example, information such as the mail address of the transmission destination of the image read by the scan function, the fax number of the destination to which the image has been sent by the fax function, etc. Accordingly, the administrator can check whether the scan image or the fax image has been sent to an unauthorized destination. Furthermore, by the preview link 1108, the administrator can view and print the document that has been sent, similar to the case of FIG. 11A.

Referring back to FIG. 8, the description of the flowchart is continued.

In step S811, when the user's process is ended, the image forming apparatus 101 performs a logout process, and ends the process.

When the process shifts to step S812, for example, the image forming apparatus 101 reports an authentication error to the client PC 102, and the process ends.

Next, a description is given of a the flow of a specific process when the user, whose application information has been approved for outside usage hours of the image forming apparatus 101, uses the image forming apparatus 101 during the approved usage period. Note that the process for within usage hours is the same as that of a regular image forming apparatus, and therefore descriptions are omitted herein.

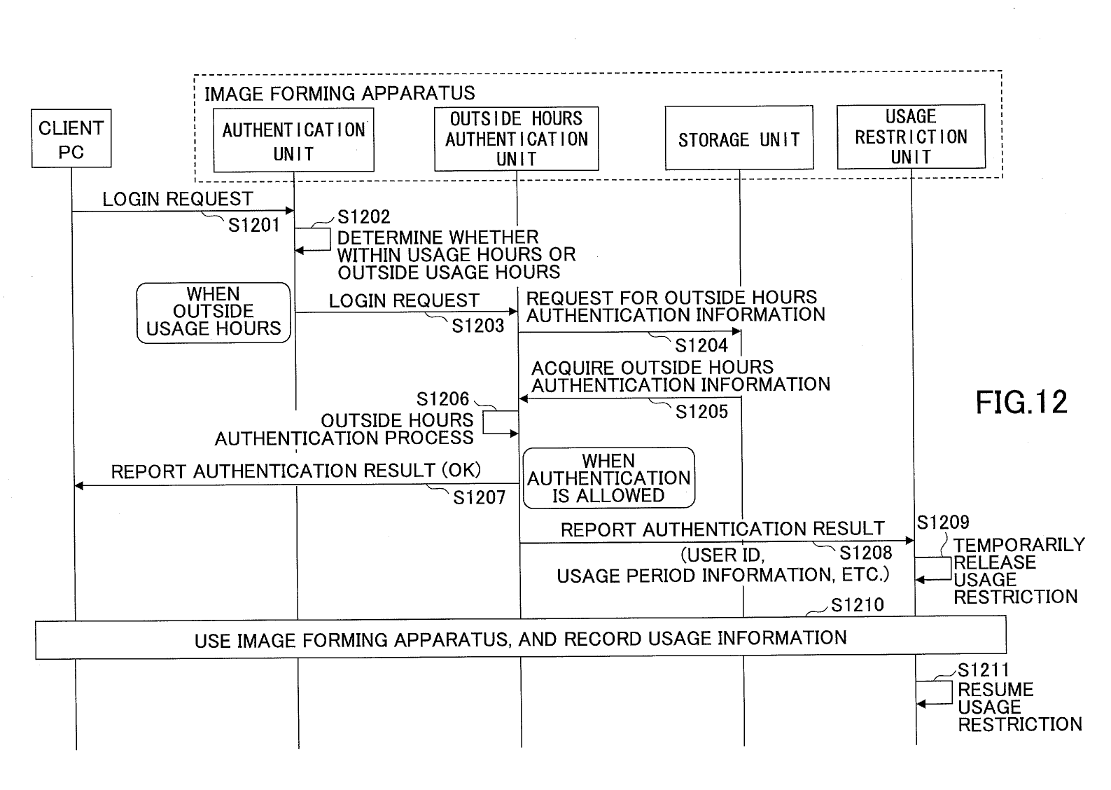

FIG. 12 is a sequence chart of an authentication process outside usage hours according to the first embodiment. In step S1201, when a login request is received from the client PC 102, the authentication unit 403 of the image forming apparatus 101 determines whether the present time is outside usage hours or within usage hours (step S1202). When the authentication unit 403 determines that the present time is outside usage hours, the authentication unit 403 reports the login request to the outside hours authentication unit 411 (step S1203). Meanwhile, when the authentication unit 403 determines that the present time is within usage hours, the authentication unit 403 uses the within hours authentication unit 412 to perform a within hours authentication process that is a regular authentication process.

The outside hours authentication unit 411 that has received the login request requests the storage unit 407 to acquire the outside hours authentication information 417 (step S1204), and acquires the outside hours authentication information 417 (step S1205). Furthermore, the outside hours authentication unit 411 uses the acquired outside hours authentication information 417 to perform an outside hours authentication process on the received login request (step S1206).

In step S1206, when the outside hours authentication is allowed, the outside hours authentication unit 411 reports an authentication result indicating that the authentication has been allowed, to the client PC 102 and the usage restriction unit 401 (steps S1207, S1208). Preferably, the authentication result reported to the usage restriction unit 401 by the outside hours authentication unit 411 includes information of the usage period of the user for which outside hours authentication has been allowed.

The usage restriction unit 401, which has received the authentication result indicating that the authentication has been allowed, temporarily releases the usage restriction of the image forming apparatus 101 (step S1209). Accordingly, the user is able to use the image forming apparatus 101 by using, for example, the client PC 102. Furthermore, the usage contents by the user are recorded as the usage information 413 by the recording unit 404 (step S1210).

When the user finishes using the image forming apparatus 101 and logs out, or when the usage period reported from the outside hours authentication unit 411 ends, the usage restriction unit 401 resumes the usage restriction of the image forming apparatus 101 (step S1211).

### MODIFICATION EXAMPLE

In the above embodiment, a description is given of an example in which the outside hours authentication unit 411 controls the usage restriction of the image forming apparatus 101, mainly based on the identification information of the user (user ID 602) and the usage period (start time 603 and end time 604).

In the above method, for example, when a first user receives approval from an approver, and while the first user is performing a printing operation with the image forming apparatus 101 outside usage hours, for example, a second user who has not received approval may perform image processing such as copying with the image forming apparatus 101.

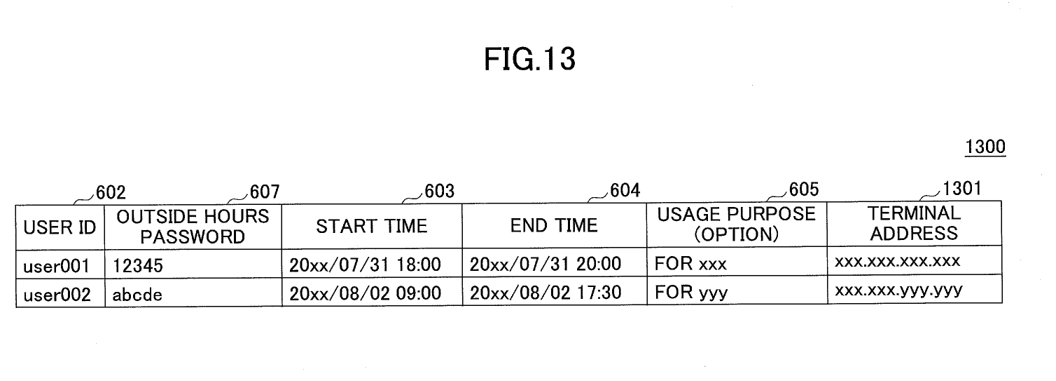

Thus, in order to further improve security, as illustrated in FIG. 13, outside hours authentication information 1300 may include a terminal address 1301 which is information for identifying the client PC 102, in addition to the outside hours authentication information 417 illustrated in FIG. 10B. The terminal address 1301 is, for example, information such as an IP address, a MAC address, etc., of the client PC 102. The terminal address 1301 of the client PC 102 may be acquired, for example, when the client PC 102 accesses the application page provided by the receiving unit 408.

For example, the outside hours authentication unit 411 reports, to the usage restriction unit 401, the terminal address 1301 in addition to the user ID 602 and the usage period information, when reporting the authentication result to the usage restriction unit 401 in step 51208 of FIG. 12. Furthermore, in step S1210 of FIG. 12, the usage restriction unit 401 allows only the client PC 102 having the reported terminal address 1301, to use the image forming apparatus 101. Accordingly, during outside usage hours, it is possible to prevent any operations other than those from the client PC 102 that has been approved by the administrator, and the security of the information processing system 100 can be further improved.

### Second Embodiment

At least some of the units included in the image forming apparatus 101 according to the first embodiment may be included in an external server, etc.

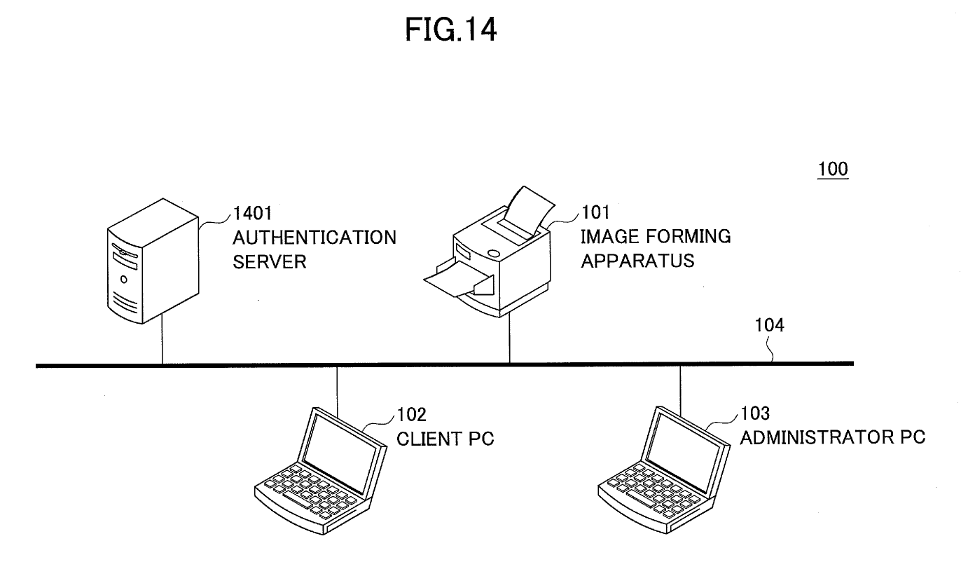

FIG. 14 illustrates a configuration example of the information processing system 100 according to the second embodiment. The information processing system 100 illustrated in FIG. 14 includes an authentication server 1401, in addition to the information processing system 100 according to the first embodiment illustrated in FIG. 1. Note that the authentication server 1401 has a hardware configuration of a general computer, such as that illustrated in FIG. 3.

### <Functional Configuration>

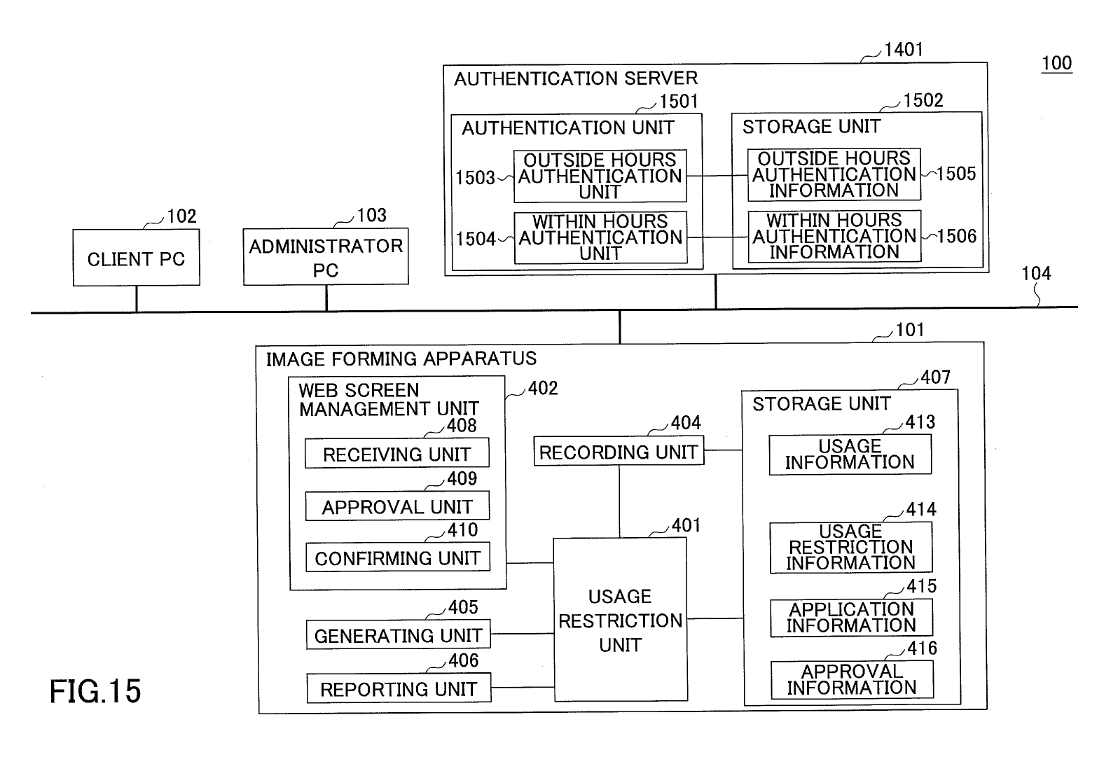

FIG. 15 illustrates a functional configuration of the information processing system 100 according to the second embodiment. The authentication server 1401 according to the second embodiment includes an authentication unit 1501 and a storage unit 1502.

The authentication unit 1501 corresponds to the authentication unit 403 in the functional configuration diagram according to the first embodiment illustrated in FIG. 4, and is realized by, for example, programs, etc., operating in the CPU 301 illustrated in FIG. 3. Furthermore, the authentication unit 1501 according to the present embodiment does not only authenticate the image forming apparatus 101, but can also authenticate a plurality of image forming apparatuses, information processing apparatuses, etc.

The authentication unit 1501 includes an outside hours authentication unit 1503 corresponding to the outside hours authentication unit 411 of FIG. 4, and a within hours authentication unit 1504 corresponding to the within hours authentication unit 412 of FIG. 4.

The storage unit 1502 stores outside hours authentication information 1505 that is authentication information used by the outside hours authentication unit 1503, and within hours authentication information 1506 that is authentication information used by the within hours authentication unit 1504.

Note that the image forming apparatus 101 according to the present embodiment may not include the authentication unit 403, the outside hours authentication information 417, the within hours authentication information 418, etc. Furthermore, the functional elements other than the authentication unit 403, the outside hours authentication information 417, and the within hours authentication information 418 may be the same as those of the first embodiment.

### <Process Flow>

### (Application, Approval Process)

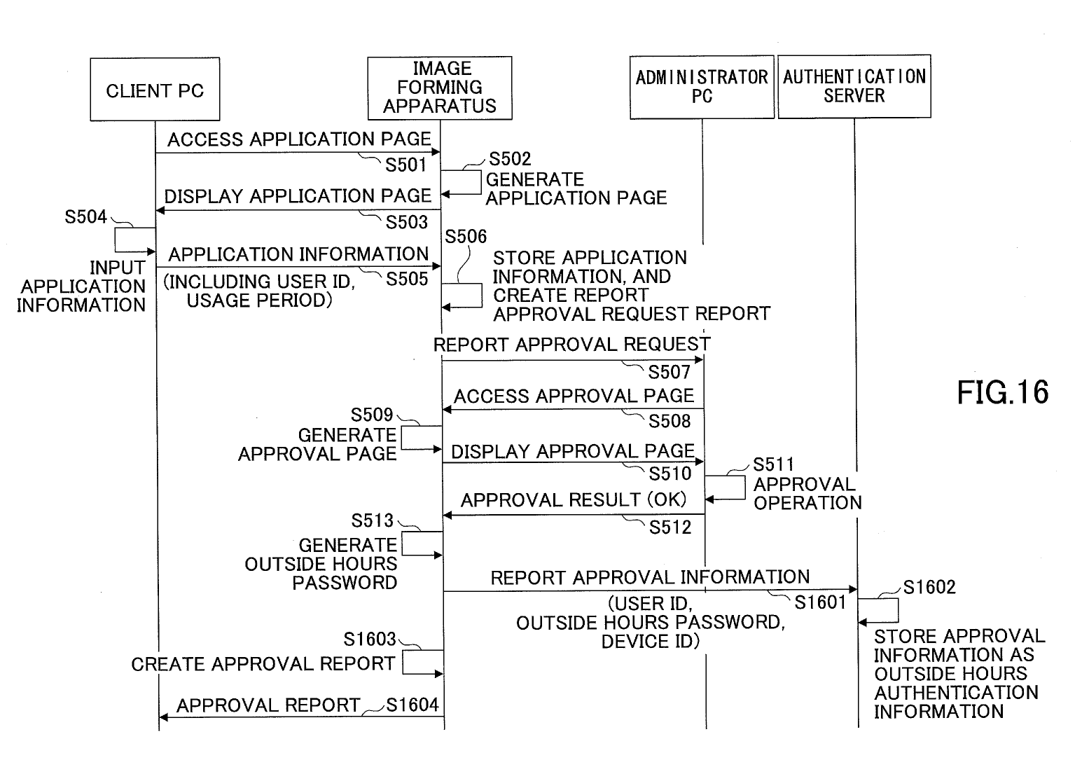

FIG. 16 is a sequence chart indicating an example of an application, approval process according to the second embodiment. Note that steps S501 through S513 in FIG. 16 are the same as the first embodiment, and therefore the differences between the first embodiment and the second embodiment are mainly described herein.

In step S1601, the image forming apparatus 101 sends, to the authentication server 1401, approval information including the device ID that is identification information of the image forming apparatus 101, in addition to the approval information 416 according to the first embodiment illustrated in FIG. 6.

In step S1602, the authentication server 1401 stores the received approval information in the storage unit 1502 as the outside hours authentication information 1505.

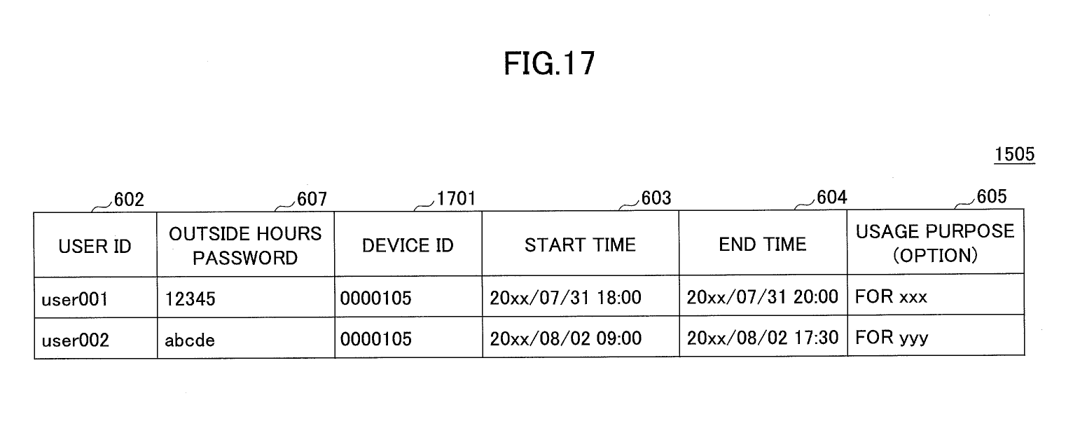

FIG. 17 illustrates an example of the outside hours authentication information 1505 according to the second embodiment. The outside hours authentication information 1505 according to the present embodiment includes a device IC 1701 that is identification information of the image forming apparatus 101, in addition to the outside hours authentication information 417 according to the first embodiment illustrated in FIG. 10B. Furthermore, similarly, it is assumed that the within hours authentication information 1506 includes a device ID for distinguishing between a plurality of image forming apparatuses and information processing apparatuses, in addition to the within hours authentication information 418 according to the first embodiment illustrated in FIG. 10A. Accordingly, the authentication unit 1501 of the authentication server 1401 can distinguish between a plurality of image forming apparatuses and information processing apparatuses, and perform an authentication process for each apparatus.

### (Usage Process)

Next, a description is given of a usage process by the entire information processing system 100 outside usage hours of the image forming apparatus 101.

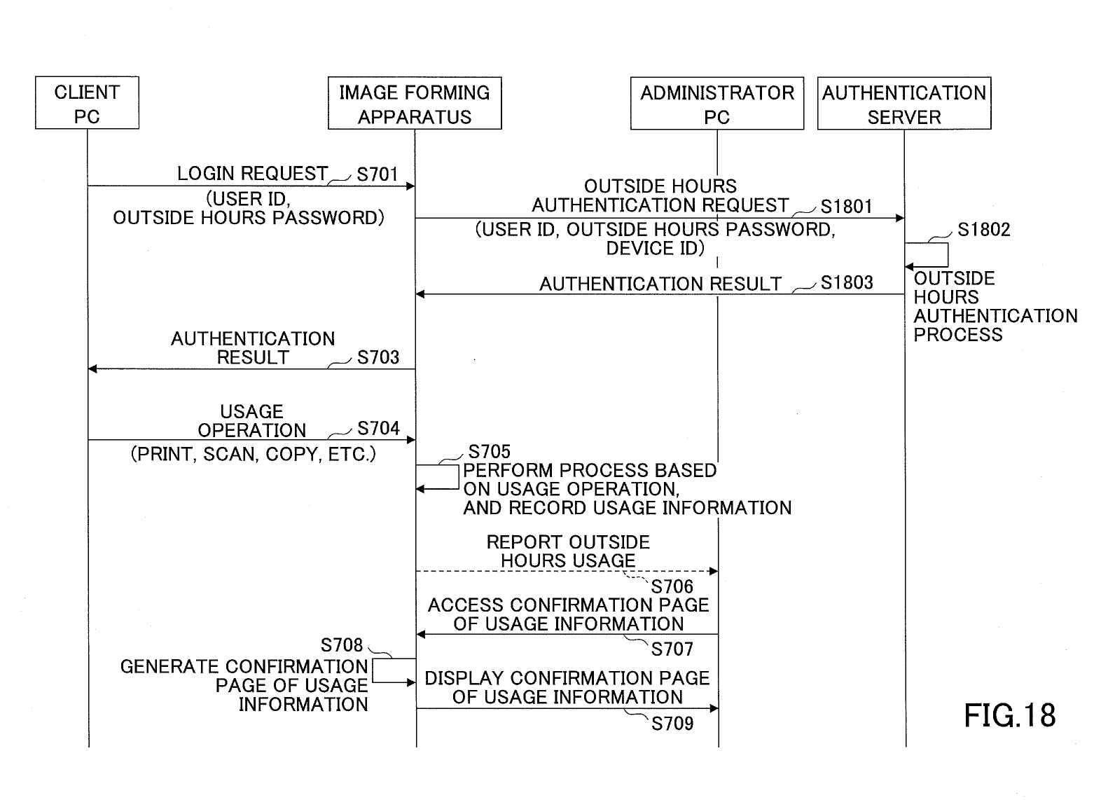

FIG. 18 is a sequence chart indicating an example of a usage process outside usage hours according to the second embodiment.

Note that steps S701 and S703 through S709 in FIG. 18 are the same as the first embodiment, and therefore the differences between the first embodiment and the second embodiment are mainly described herein.

When the image forming apparatus 101 receives a login request from the client PC 102 outside usage hours of the image forming apparatus 101 (step S701), the image forming apparatus 101 sends an outside hours authentication request to the authentication server 1401 (step S1801). This outside hours authentication request includes the device IC 1701 of the image forming apparatus 101, in addition to the user ID 602 and the outside hours password 607.

When the authentication server 1401 receives the outside hours authentication request from the image forming apparatus 101, the outside hours authentication unit 1503 uses the outside hours authentication information 1505 to perform outside hours authentication on the login request (step S1802).

The authentication server 1401 sends the authentication result by the outside hours authentication unit 1503, to the image forming apparatus 101. Note that FIG. 18 illustrates an example where the authentication by the outside hours authentication unit 1503 is successful. Thereafter, from step S703 and onward, the process is performed in the same manner as the first embodiment.

Note that the system configurations of the above embodiments are merely examples; the information processing system 100 may have various system configurations. For example, in FIG. 15, the web screen management unit 402 may be included in a web server, etc., connected to the network 104, and the storage unit 407 may be stored by a storage server, etc., connected to the network 104.

### <Overview>

An information processing apparatus (101) according to the present embodiment is an information processing apparatus (101) for providing a predetermined function, which includes a usage restriction unit (401) configured to restrict usage of the information processing apparatus (101) in a time period defined in advance. Furthermore, the information processing apparatus (101) includes a receiving unit (408) configured to receive application information for applying to use the information processing apparatus (101) in the time period defined in advance, and an approval unit (409) configured to perform an approval process on the application information received by the receiving unit (408). Furthermore, the information processing apparatus (101) includes an outside hours authentication unit (411) configured to authenticate a user of the information processing apparatus (101) by using outside hours authentication information (417) based on the application information approved by the approval unit, in the time period defined in advance.

By the above configuration, the information processing apparatus (101) can implement a usage restriction of the information processing apparatus (101) in a time period defined in advance, and can allow usage of the information processing apparatus (101) only for a user who has been approved to use the information processing apparatus (101) in advance, in the time period during which usage is restricted. Accordingly, it is possible to provide an information processing apparatus (101) capable of easily suppressing usage for purposes other than the intended purpose while allowing usage within a predetermined time period, when usage of the information processing apparatus (101) is restricted in the predetermined time period.

Preferably, the outside hours authentication information (417) includes identification information (602) of a user approved by the approval unit (409), and information (603 and 604) indicating a usage period approved by the approval unit (409). Accordingly, the information processing apparatus (101) can allow usage for a user who has been approved by the approval unit (409), within a range of the usage period approved by the approval unit (409), in the time period during which usage of the information processing apparatus (101) is restricted.

Preferably, the information processing apparatus (101) includes a generating unit (405) configured to generate authentication information (607) corresponding to the application information approved by the approval unit (409), wherein the outside hours authentication information (417) includes the authentication information (607) generated by the generating unit (405). Accordingly, the information processing apparatus (101) can allow usage of the information processing apparatus (101) only for a user having the authentication information (607) corresponding to the application information approved by the approval unit (409), in the time period during which usage of the information processing apparatus (101) is restricted.

Preferably, the information processing apparatus (101) includes a recording unit (404) configured to record usage information (413) of the information processing apparatus, in the time period defined in advance. Furthermore, the usage information (404) includes information (1104) for identifying the user of the information processing apparatus (101), and information (1108, etc.) for identifying contents of a process performed by the information processing apparatus (101). Accordingly, the administrator of the information processing apparatus (101) is able to recognize what kind of process has been performed by the information processing apparatus (101), in the time period during which usage of the information processing apparatus (101) is restricted.

Note that the above reference numerals in parenthesis are applied for facilitating understanding, but are merely examples, and do not limit the scope of the present invention.

According to one embodiment of the present invention, an information processing apparatus, an information processing system, and a control method of an information processing apparatus are provided, which are capable of easily suppressing usage for purposes other than the intended purpose while allowing usage within a predetermined time period, when usage of the information processing apparatus is restricted in the predetermined time period.

The information processing apparatus, the information processing system, and the control method of the information processing apparatus are not limited to the specific embodiments described herein, and variations and modifications may be made without departing from the spirit and scope of the present invention.

The present invention can be implemented in any convenient form, for example using dedicated hardware, or a mixture of dedicated hardware and software. The present invention may be implemented as computer software implemented by one or more networked processing apparatuses. The network can comprise any conventional terrestrial or wireless communications network, such as the Internet. The processing apparatuses can compromise any suitably programmed apparatuses such as a general purpose computer, personal digital assistant, mobile telephone (such as a WAP or 3G-compliant phone) and so on. Since the present invention can be implemented as software, each and every aspect of the present invention thus encompasses computer software implementable on a programmable device. The computer software can be provided to the programmable device using any storage medium for storing processor readable code such as a floppy disk, hard disk, CD ROM, magnetic tape device or solid state memory device.)

The present application is based on and claims the benefit of priority of Japanese Priority Patent Application No. 2014-238932, filed on Nov. 26, 2014, the entire contents of which are hereby incorporated herein by reference.

What is claimed is:

1. An information processing apparatus for providing a predetermined function, the information processing apparatus comprising:
a usage restriction unit configured to restrict usage of the information processing apparatus in a time period defined in advance;
a receiving unit configured to receive application information for applying to use the information processing apparatus in the time period defined in advance;
an approval unit configured to perform an approval process on the application information received by the receiving unit; and
an outside hours authentication unit configured to authenticate a user of the information processing apparatus by using outside hours authentication information based on the application information approved by the approval unit, in the time period defined in advance.

2. The information processing apparatus according to claim 1, wherein
the outside hours authentication information includes
identification information of a user approved by the approval unit, and
information indicating a usage period approved by the approval unit.

3. The information processing apparatus according to claim 2, further comprising:
a generating unit configured to generate authentication information corresponding to the application information approved by the approval unit, wherein
the outside hours authentication information includes the authentication information generated by the generating unit.

4. The information processing apparatus according to claim 2, wherein
when the authentication by the outside hours authentication unit is allowed,
the usage restriction unit allows the usage of the information processing apparatus, within a range of the approved usage period.

5. The information processing apparatus according to claim 1, further comprising:
a recording unit configured to record usage information of the information processing apparatus, in the time period defined in advance, wherein
the usage information includes
information for identifying the user of the information processing apparatus, and
information for identifying contents of a process performed by the information processing apparatus.

6. The information processing apparatus according to claim 1, wherein
the receiving unit provides a web page for applying to use the information processing apparatus in the time period defined in advance, and
the approval unit provides a web page for approving the received application information.

7. The information processing apparatus according to claim 3, wherein
when the authentication by the outside hours authentication unit is allowed,
the usage restriction unit allows the usage of the information processing apparatus, within a range of the approved usage period.

8. The information processing apparatus according to claim 2, further comprising:
a recording unit configured to record usage information of the information processing apparatus, in the time period defined in advance, wherein
the usage information includes
information for identifying the user of the information processing apparatus, and
information for identifying contents of a process performed by the information processing apparatus.

9. An information processing system including a first information processing apparatus for providing a predetermined function and a second information processing apparatus for managing the first information processing apparatus, the information processing system comprising:
a usage restriction unit configured to restrict usage of the first information processing apparatus in a time period defined in advance;
a receiving unit configured to receive application information for applying to use the first information processing apparatus in the time period defined in advance;
an approval unit configured to perform an approval process on the application information received by the receiving unit; and
an outside hours authentication unit configured to authenticate a user of the first information processing apparatus by using outside hours authentication information based on the application information approved by the approval unit, in the time period defined in advance.

10. The information processing system according to claim 9, wherein
the outside hours authentication information includes
identification information of a user approved by the approval unit, and
information indicating a usage period approved by the approval unit.

11. The information processing system according to claim 10, wherein
a generating unit configured to generate authentication information corresponding to the application information approved by the approval unit, wherein
the outside hours authentication information includes the authentication information generated by the generating unit.

12. The information processing system according to claim 10, wherein
when the authentication by the outside hours authentication unit is allowed,
the usage restriction unit allows the usage of the first information processing apparatus, within a range of the approved usage period.

13. The information processing system according to claim 9, wherein
a recording unit configured to record usage information of the first information processing apparatus, in the time period defined in advance, wherein
the usage information includes
information for identifying the user of the first information processing apparatus, and
information for identifying contents of a process performed by the first information processing apparatus.

14. The information processing system according to claim 9, wherein
the receiving unit provides a web page for applying to use the first information processing apparatus in the time period defined in advance, and
the approval unit provides a web page for approving the received application information.

15. A control method of an information processing apparatus for providing a predetermined function, the control method comprising:
restricting, by the information processing apparatus, usage of the information processing apparatus in a time period defined in advance;
receiving, by the information processing apparatus, application information for applying to use the information processing apparatus in the time period defined in advance;
performing, by the information processing apparatus, an approval process on the application information received at the receiving; and
authenticating, by the information processing apparatus, a user of the information processing apparatus by using outside hours authentication information based on the application information approved by the approval process, in the time period defined in advance.

16. The control method according to claim 15, wherein
the outside hours authentication information includes
identification information of a user approved by the approval unit, and
information indicating a usage period approved by the approval unit.

17. The control method according to claim 16, further comprising:
generating, by the information processing apparatus, authentication information corresponding to the application information approved by the approval process, wherein
the outside hours authentication information includes the authentication information generated at the generating.

18. The control method according to claim 16, wherein
when the authentication by the information processing apparatus is allowed,
the restricting includes allowing the usage of the information processing apparatus, within a range of the approved usage period.

19. The control method according to claim 15, further comprising:
recording, by the information processing apparatus, usage information of the information processing apparatus, in the time period defined in advance, wherein
the usage information includes
information for identifying the user of the information processing apparatus, and
information for identifying contents of a process performed by the information processing apparatus.

20. The control method according to claim 15, wherein
the receiving includes providing a web page for applying to use the information processing apparatus in the time period defined in advance, and
the performing of the approval process includes providing a web page for approving the received application information.
